(19) United States
(12) Patent Application Publication
(10) Pub. No.: US 2012/0185604 A1
(43) Pub. Date: Jul. 19, 2012

(54) SYSTEM AND METHOD FOR INDICATING CALLEE PREFERENCES

(76) Inventor: Alexander Shatsky, Waterloo (CA)

(21) Appl. No.: 13/006,856

(22) Filed: Jan. 14, 2011

(51) Int. Cl. G06F 15/16

(52) U.S. Cl. 709/228

(57) ABSTRACT

A system and method of communicating callee device preferences to a network is present. A first device identification is transmitted. The first device identification at least one of identifies the callee device and describes a capability of the callee device. A caller capabilities pattern is encoded into a first session initiation protocol (SIP) message. The caller capabilities pattern describes an attribute of a candidate caller device. An action pattern is encoded into the first SIP message. The action pattern defines an action and the network is configured to take the action. The action pattern is associated with the caller capabilities pattern. The first SIP message is transmitted to the network.

### BACKGROUND

The present disclosure relates generally to communication systems and, more specifically, to a system and method for communicating callee preferences in internet protocol (IP) multimedia subsystem (IMS) or session initiation protocol (SIP) networks.

As used herein, the terms device, user equipment (UE), mobile station (MS) and user agent (UA) are generally synonymous and may refer to electronic devices such as fixed and mobile telephones, personal digital assistants (PDAs), handheld or laptop computers, smartphones, printers, fax machines, televisions, set-top boxes, and other video display devices, home audio equipment or other home entertainment systems, home monitoring and control systems (e.g., home monitoring, alarm systems, or climate control systems), enhanced home appliances such as computerized refrigerators and similar devices that have network communications capabilities. UE may refer to a mobile, wireless device.

The terms may also refer to devices that have similar capabilities but that are not readily transportable, such as desktop computers, set-top boxes, TVs, IPTVs or network nodes. The terms may also cover SIP User Agents (UAs) that can be fixed or mobile. When a UE is a network node, for example, the network node may act on behalf of another function such as a UE or a fixed line device and simulate or emulate the UE or fixed line device. For some UEs, the IMS SIP client that would typically reside on the device itself may instead reside in the network and relay SIP message information to the device using optimized protocols. In other words, some functions that were traditionally carried out by a UE can be distributed in the form of a remote UE, where the remote UE represents the UE in the network. The term “UE” can also refer to any hardware or software component that can terminate a communication session that could include, but is not limited to, a SIP session. Those skilled in the art will appreciate that these terms can be used interchangeably within the application.

When communicating using a wireless network, various protocols can be implemented for allowing communication between a UE and the network. One example protocol, as defined in Third Generation Partnership Project (3GPP) systems, includes an IMS that allows for the delivery of IP multimedia services. Using IMS, a UE can transmit and receive multimedia and/or voice packet switched (PS) communications via a base station or access device implementing one or more IMS Functional Component. To implement IMS, networks rely upon SIP to provide a text-based signaling protocol that can be used to communicate between a UE and the IMS Core Network (CN), between the IMS CN and Application Servers, and between various other components of the IMS Network. SIP messages may include several categories of message including SIP method, SIP request or SIP response messages. Generally, the terms SIP method and SIP request are interchangeable and refer to similar SIP message types.

In general, these protocols use a request-response communication strategy. As such, when communicating, preliminary messages such as request messages are sent by a first entity. When the request message attempts to initiate a communication, the first entity may be referred to as a caller or caller device. The request messages are received and processed by a callee device and response messages are constructed and transmitted back to the caller. These combinations of sent messages and response messages allow for the communication of data and protocol states between caller and callee devices. Generally, the term callee refers to an entity of IMS/SIP network that terminates a SIP transaction or dialog. As such, both a device and an IMS/SIP networking component (including Application Servers and CN components of the IMS network) may function as callee devices.

In existing networks, before receiving a communication request, a callee device may communicate the device's capabilities for IMS/SIP networks to the network. The capabilities may include a listing of applications, services and/or media types supported by the device, priority, media feature tags, or other information and may be transmitted using a SIP REGISTER request as described in IETF RFC 3840 Indicating User Agent Capabilities in the Session Initiation Protocol (SIP). The capabilities allow the network to determine which devices are capable of receiving and processing particular communication protocols or data types. After the SIP REGISTER request with the callee's capabilities is received, for example, and processed by the network (e.g., via a serving call session control function (S-CSCF)), the information is stored in the S-CSCF/home subscriber server (HSS), or another subscriber database for later use by the network.

When a caller device wishes to communicate with the callee device, the caller queries the stored callee device's capabilities using a SIP OPTIONS request. Using the capabilities information provided in the response to the SIP OPTIONS request, the caller can match the caller's own capabilities or preferences with the callee's capabilities and determine whether the callee is capable of handling the call or requested service.

Although a callee can express the callee's capabilities in a SIP REGISTER request as described above, there is no mechanism in IMS or SIP to explicitly specify which session or transaction types the callee is willing to handle—it is presumed that a callee device is willing to accept all sessions or transactions that use a communication protocol or media type that the callee device can handle. The callee device is also unable to control how IMS/SIP network components treat sessions or transactions that do not match the callee's capabilities. As a result, user experience deteriorates, the number of failed sessions/transactions increases, load on IMS/SIP and Wireless networks is increased and/or load on the IMS CN and Service Plane equipment is increased.

As an illustration of these difficulties, the following example is presented. In the example, calls are inconveniently forwarded to a first user's IPTV device, resulting in a deterioration of the first user's viewing experience. The first user has two separate devices, with the first device being an IPTV device providing an Internet protocol television (IPTV) application and the second device being a mobile phone supporting voice communications. The first device supports video and audio capabilities and, using existing SIP messaging, the first user indicates the first device's ability to support video and audio to the IMS network using feature tags of the Contact-header of a SIP REGISTER request as illustrated in Table 1. The information regarding the first device's capabilities is then stored in an S-CSCF (or HSS or another server) to reflect that the IPTV device has audio, video capabilities, and it supports “an-IPTV-application”.

TABLE 1
Contact:<sip:alice@example.com>;[header=”Contact”];audio;video;+g.3gpp.iari-ref=″
urn:urn-7:3gpp-service.ims.icsi.iptv″

A second user has a third device that provides a phone application. The second user wishes to call the first user using the third device. Before making a call or session origination to the first user, however, the third device fetches the first user's capabilities (e.g. by subscribing to the Presence information of the first user via OMA Presence/SIMPLE or the Presence Access Layer, or by sending a SIP OPTIONS request) and discovers that the first user has two devices that support audio capabilities—the first device (the IPTV device) and the second device (the mobile phone).

After retrieving the capability information, the second user originates a call or session to the first user with the IMS Communication Service Identifier (ICSI) value (see, for example 3GPP TS 23.228 IP Multimedia Subsystem (IMS); Stage 2) in the P-Preferred Service header of the INVITE request set to multi-media telephony service (e.g., mmtel) to indicate to the IMS core network (CN) that the call or session should be processed by the mmtel service. The network then replaces the P-Preferred Service header with a P-Asserted-Service header after validating the request is compatible with the mmtel service identified in the P-Preferred Service header and that the user is appropriately authorized. Generally, mmtel is a global standard based on the IP Multimedia Subsystem (IMS). Mmtel allows for communication using various forms of media including voice, real-time video, text, file transfer and sharing of pictures, audio and video clips. Using mmtel, users have the capability to add and/or drop media during a session. Accordingly, users may first initiate a communication using a first media type and can later add or remove media types and/or users to the communication. Mmtel is further described in 3GPP TS 24.173.

The INVITE request is communicated to the first user's S-CSCF and, because the second user's device is unable to explicitly specify its preference for the type of the device to be contacted first (because the second user's device is voice call capable but doesn't support the Mmtel service), the S-CSCF processes and routes the call or session to the mmtel server. The mmtel server then contacts the first user's mobile phone (the second device), but the first user does not answer the call or session as the first user is watching a movie on the first device (the IPTV device) and does not wish to be disturbed.

Because the call is not answered by the mmtel service, the S-CSCF looks up the list of the first user's bindings, and, because the IPTV device has indicated support of the audio media feature tag, the S-CSCF routes the call or session to the first user's IPTV device again interrupting the first user's viewing. In this example, the first user only wishes to use the IPTV device for IPTV sessions and not for voice calls. Accordingly, the request for the phone call gets manually rejected by the first user at the IPTV.

Without a mechanism to indicate to the SIP/IMS network that the IPTV device is not willing to handle calls or sessions that are originated by a device that does not support the same applications or services as the IPTV device, phone calls that are ignored at the first user's phone will routinely be forwarded to the user's IPTV device, interrupting use of that device.

In a second example, several users participate in a multiparty game that can be played using PCs and laptops. A limited version of the game is available for mobile devices, but it is not generally preferable to play a group game with players using mobile devices. The game is organized as a conference call hosted by a first user. To participate, players call into the conference call to join the game. Existing network provide no mechanism for limiting the types of devices that may join a group game.

When hosting the game, even if it is preferred that only players using PCs or laptops connect (i.e., the full version of the game), there is no mechanism to automatically limit participation to only those players using PC and laptops. As a result, players that are connecting using the mobile device application are not restricted from joining. Accordingly, all game requests, even those including mobility=“mobile”, are accepted and players using the mobile device application are allowed to freely join the game. To reject the users, the game host must then manually reject players joining with mobile devices and provide them with an explanation of why their request has been rejected. This can result in reduced battery life for wireless mobile devices and further increase overall network load (i.e. due to failed calls).

In another example, an Application Server (AS) may reach maximum capacity for the number of subscriptions the AS can accept. In existing networks, the AS has no mechanism to indicate to the SIP/IMS network that the AS is no longer capable of handling new subscriptions, and that the network should reject or redirect new subscriptions.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an illustration of a method to construct and provision callee preferences using a SIP request including Accept-Contact (or Allow-Contact) or/and Reject-Contact (or Decline-Contact) headers;

FIG. 2 is an illustration of a method to modify a callee preference using a SIP request including a modified Accept-Contact or/and Reject-Contact headers;

FIG. 3 is a diagram of a wireless communications system including a UE operable for some of the various embodiments of the disclosure;

FIG. 4 is a block diagram of a UE operable for some of the various embodiments of the disclosure;

FIG. 5 is a diagram of a software environment that may be implemented on a UE operable for some of the various embodiments of the disclosure; and

FIG. 6 is an illustrative general purpose computer system suitable for some of the various embodiments of the disclosure.

### DETAILED DESCRIPTION

The present disclosure relates generally to communication systems and, more specifically, to a system and method for communicating callee preferences in internet protocol (IP) multimedia subsystem (IMS) or session initiation protocol (SIP) networks.

To this end, some embodiments include a method of communicating callee device preferences to a network. The method includes transmitting a first device identification. The first device identification at least one of identifies the callee device and describes a capability of the callee device. The method includes encoding a caller capabilities pattern into a first session initiation protocol (SIP) message. The caller capabilities pattern describes an attribute of a candidate caller device. The method includes encoding an action pattern into the first SIP message. The action pattern defines an action and the network is configured to take the action. The action pattern is associated with the caller capabilities pattern. The method includes transmitting the first SIP message to the network.

Other embodiments include a method of receiving callee device preferences. The method includes receiving a first device identification. The first device identification at least one of identifies a callee device and describes a capability of the callee device. The method includes receiving a first session initiation protocol (SIP) message. The first SIP message includes a caller capabilities pattern encoded into the first SIP message, the caller capabilities pattern describes an attribute of a candidate caller device, and an action pattern encoded into the first SIP message. The action pattern defines an action and the action pattern is associated with the caller capabilities pattern. The method includes using the caller capabilities pattern and the action pattern to process requests directed to the first device.

Other embodiments include a user equipment comprising a processor configured to transmit a first device identification. The first device identification at least one of identifies a callee device and describes a capability of the callee device. The processor is configured to encode a caller capabilities pattern into a first session initiation protocol (SIP) message. The caller capabilities pattern describes an attribute of a candidate caller device. The processor is configured to encode an action pattern into the first SIP message. The action pattern defines an action and the action pattern is associated with the caller capabilities pattern. The processor is configured to transmit the first SIP message to a network.

Other embodiments include a network component comprising a processor configured to receive a first device identification. The first device identification at least one of identifies a callee device and describes a capability of the callee device. The processor is configured to receive a first session initiation protocol (SIP) message. The first SIP message includes a caller capabilities pattern encoded into the first SIP message, the caller capabilities pattern describes an attribute of a candidate caller device, and an action pattern encoded into the first SIP message. The action pattern defines an action and the action pattern is associated with the caller capabilities pattern. The processor is configured to use the caller capabilities pattern and the action pattern to process requests directed to the first device.

To the accomplishment of the foregoing and related ends, the disclosure, then, comprises the features hereinafter fully described. The following description and the annexed drawings set forth in detail certain illustrative aspects of the disclosure. However, these aspects are indicative of but a few of the various ways in which the principles of the disclosure can be employed. Other aspects, advantages and novel features of the disclosure will become apparent from the following detailed description of the disclosure when considered in conjunction with the drawings.

The various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

The present system and method enables a callee device to directly express a callee's preferences for specifying session or transaction types the callee is willing to handle. Using the preferences, a callee is able to provide a set of configurations to a networking component (e.g., a SIP/IMS networking component) for each available callee device. For each callee device, the preferences include a set of rules for identifying and processing requests from candidate caller devices, the caller devices being identified by a particular set of characteristics and capabilities. The preferences also instruct the network component regarding how to handle sessions or transactions that do not match (or do match) the callee's preferences (e.g., via a default set of preference rules).

Using the present system, a callee may indicate its preferences with regards to the handling of incoming SIP sessions or transactions by creating a listing of preferences and provisioning the preferences to a component of a SIP or IMS network. Candidate IMS networking components for hosting the preferences include, for example, P-CSCF, S-CSCF, MGCF, Application Servers, other network nodes, etc. The present system and method may apply to various networking components of IMS and SIP networks. A mapping between networking components of IMS and SIP networks is provided below in Table 2.

TABLE 2

| IMS Network | SIP Network |
|---|---|
| AS | SIP Application Server (e.g. IP-PBX, SIP Presence |
| | Server, etc) |
| HSS | User/Subscriber Database |
| IBCF | SBC (Session Border Controller) |
| I-CSCF | SIP Proxy |
| P-CSCF | SIP Proxy |
| S-CSCF | SIP Registrar and/or SIP Proxy |
| UE | UE (SIP User Agent) |

In the present system, a callee's preferences can include several preference elements. The preference elements are used to identify the callee's device's capabilities in addition to capabilities for one or more candidate caller device and actions to take when receiving incoming requests from a caller device. The preference elements can also be used to define particular actions for the network to take upon receiving a message, or processing a call or session request from a caller having capabilities that match the defined capabilities within the preferences. Additional preference elements may be used to define parameters for specifying whether a particular action is optional or mandatory, for example.

Within a first callee device's preferences, a first preference element includes data that describes the callee device's contact information (possibly including multiple contact identifications) and capabilities. The data may include, for example, the device contact information (e.g., Globally Routable User Agent Uniform Resource Indicator (GRUU), Public User Identity, IP address etc); the callee device's services (ICSI); and/or applications (IARI) to which the preferences are to be applied. As understood by those skilled in the art, this mechanism can allow the preferences for multiple devices of a single user to be established from a single device. As such, the resulting mechanism represents an improvement over existing mechanisms (e.g. simply reflecting callee capabilities via IETF RFC 3840, on a device-by-device basis).

A second preference element is used to identify candidate caller devices. The second preference element may include particular caller capability patterns, caller preferences, and caller service or application identifiers. Using the second preference element, the callee can identify particular classes or types of caller devices to which the preferences are to be applied. If a call or session is initiated by a caller device having capabilities that match those defined in the preferences, the preferences may instruct the network to take particular action to requests received from the caller device, as described below.

The caller capabilities pattern may be formatted in accordance with IETF RFC 3840 Indicating User Agent Capabilities in the Session Initiation Protocol (SIP). The capabilities may include, for example, “actor”, “application”, “audio”, “automata”, “class”, “control”, “duplex”, “data”, “description”, “extensions”, “events”, “isfocus”, “language”, “mobility”, “methods”, “priority”, “schemes”, “type”, “text”, and “video” parameters. The caller capabilities pattern may also list the caller's preferences as defined in IETF RFC 3841 Caller Preferences for the Session Initiation Protocol (SIP) as well as service or application identifiers (e.g., ICSI and IARI as defined in 3GPP TS 23.228 IP Multimedia Subsystem (IMS); Stage 2). Optionally, additional parameters such as Caller's Public User Identity, domain, etc. may be included in the caller capabilities pattern. Multiple capabilities may be included within a particular caller capabilities pattern. The different capabilities may be “ANDed” together, requiring that a caller device have all the listed capabilities before the pattern is matched. Alternatively, the capabilities may be “ORed” together requiring that a caller device have only a single one of the listed preferences. In other examples, the capabilities may be both ORed and ANDed together. For example, a particular pattern (e.g., A AND (B OR C)) may require that caller device have a first capability or attribute A, and one of the capabilities or attributes B and C.

The third preference element includes action patterns that are associated within the second preference element that identifies particular types of caller devices. The action patterns define actions to be taken by a network component to handle incoming sessions or transactions when a match (or mismatch) in the caller's capabilities pattern (i.e. the second preference element) is discovered.

Each action pattern may be associated with an action pattern parameter that may be used to specify whether an action pattern is optional. For example, when certain conditions are met, if the callee device is busy, the preference is to reject the caller's call or session, otherwise the preference is to route the call or session to the callee device. Alternatively, the action pattern parameters may specify that a particular action pattern is mandatory. The action parameters may include a set or a list of the actions to be executed for a certain transaction type (for example, reject the caller's call or session and send a notification to the callee), and additional optional parameters (e.g. a target caller ID or contact for call forwarding), etc.

The callee's preferences may be statically configured, or can be modified based upon execution of a particular program or database access. The preferences may be provisioned by or to different IMS network entities including, but not limited to, an IMS networking component (e.g. S-CSCF) administrator, or a device. In some cases, the directives of the network administrator are embedded in the preferences of the component.

Alternatively, a set of ‘common’ or ‘default’ preference templates can be defined to enable a user or callee device to select from a listing of available policies. For example, three different policies may be defined including example policies ‘Preference 1’ (including caller capabilities only), ‘Preference 2’ (including action pattern type/parameters only), and ‘Preference 3’ (including both caller capabilities and action pattern type/parameters). Using the default preference templates, a callee device can quickly be associated with particular preferences and the preferences can be implemented by the network.

When using the preferences, the preferences may only be applied to initial SIP requests within a SIP dialog (e.g. INVITE, SUBSCRIBE), as well as to the standalone SIP transactions (e.g. out of dialog INFO or MESSAGE). Generally, however, the preferences are not applied to in-dialog SIP requests (although they may be).

To provision the preferences, a device may use SIP subscription or registration mechanisms. For example SIP mechanisms such as REGISTER, SUBSCRIBE, NOTIFY, OPTIONS, INFO, MESSAGE, REFER, PUBLISH as well as other SIP and non-SIP mechanisms may be used to provision the preferences to the network (e.g., an IMS networking component).

In one particular implementation, when a UE sends a REGISTER (or SUBSCRIBE, OPTIONS, another) request, the UE can optionally include additional, new header fields that include the UE's callee preferences described above. When encoding the callee preferences into the new header fields, the preferences may be separated into two categories. The first category, called the allowed feature preferences, may be carried in an Allow-Contact header field. The header carries the same feature parameters that are used to indicate capabilities and describes specific behavior that is desired at a server during call or session processing. Here, the feature parameters represent the callee's preferences. The Allow-Contact header field may contain feature sets that describe capabilities of UEs that the callee would like to be reached by.

Alternately, the UE's callee preferences can be included into an XML, plain-text, binary or other body format which is carried by the aforementioned SIP messages. That is, callee preferences can be encoded as part of the message payload in a defined structure or format (e.g. conforming to an XML Schema) to be processed as part of the message. For example, the message may be decoded and processed by a call processing component executing in the network and/or within a UE as described in Internet Engineering Task Force IETF RFC 3880.

The preferences may alternatively fall into a second category called the declined feature preferences that are carried in a Decline-Contact header field within the SIP message. It can be represented by the same feature parameters that are used to indicate capabilities and describes specific behavior that is desired at a server. The Decline-Contact header field can contain feature sets which, if matched by a UE, imply that the request should not be routed to that UE.

A “directive” header parameter may optionally be presented in both headers (e.g., Accept-Contact header and Reject-Contact header) to express the callee preferences for whether the server should proxy, redirect or reject the request, and whether sequential or parallel searching is desired. These preferences can be applied at every server along the call signaling path.

The servers within the call signaling path may then use the information in the Allow-Contact and Decline-Contact header fields to select amongst contacts in their target set. When neither of the header fields are present, the server may establish explicit or implicit preferences from the request. The explicit preferences may be specified according to RFC 3841 or a local server policy, for example. The implicit callee preferences may be specified in the callee capabilities as per RFC 3840, for example. As an example, if the request method is INVITE, that may be an implicit preference to route the call to a UE that indicated the INVITE method in that UE's capabilities during the registration procedure.

The feature preferences can appear in other request types (e.g. SUBSCRIBE, OPTIONS), not just REGISTER. The preferences need to be applied to a server that determines a request target. If the domain in the request URI is not owned by any server along the request path, those servers may never access a location service, and therefore, never have the opportunity to apply the callee preferences.

After the callee preferences are provisioned to a network component (e.g., via the Allow-Contact and Decline-Contact headers), when the network component receives an incoming request from a caller device that is addressed to the callee device, the network component processes the request by applying the callee's preferences to the incoming message. If a match is found between the caller device's capabilities pattern in the preferences and the actual caller device's capabilities, the action pattern section of the preferences (if present) related to those caller capabilities is executed by the network component. The matching pattern algorithm may be similar to that described in Section 7.2 of RFC 3841 (see IETF RFC 3841 Caller Preferences for the Session Initiation Protocol (SIP)). Using such a matching pattern algorithm, for example, may facilitate integration of the present system into existing SIP and IMS networking components that are compliant with the matching mechanism in RFC 3841.

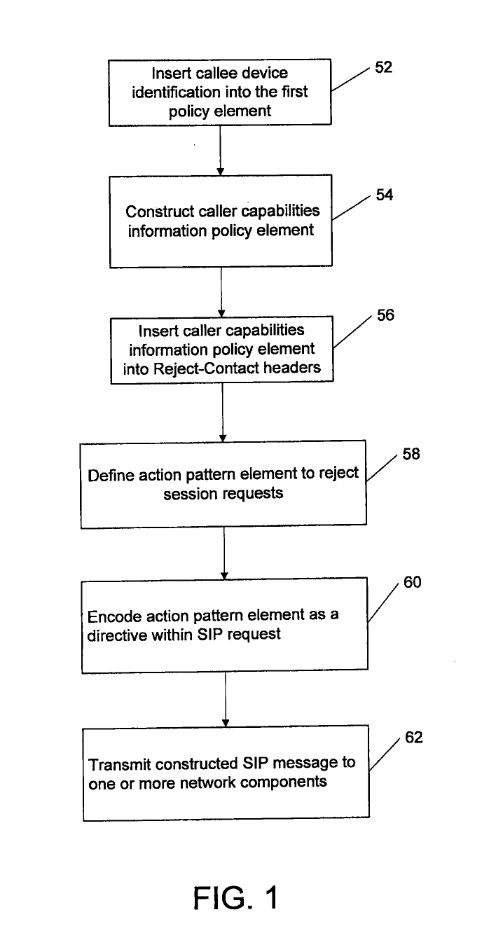

FIG. 1 is an illustration of a method to construct and provision callee preferences using a SIP request including Allow-Contact or/and Decline-Contact headers in accordance with the present disclosure. The preferences are provisioned to one or more network components that use the preferences to control session and/or transaction origination to the callee device from a caller device.

The following example is used to illustrate the present method. A first user has two separate devices. The first device is an IPTV device with an Internet protocol television (IPTV) application supporting video and audio applications and the second device is a mobile phone supporting voice communications. The first user wishes to establish preferences to prevent voice calls from being forwarded to the IPTV device, even when the voice call is ignored at the first user's phone. In the example, a second user has a third device that provides a phone application. The second user wishes to initiate a call to the first user and the first user wishes to reject calls at the IPTV device that are not received from an IPTV application.

To reject the second user's phone call at the IPTV device, the first user's IPTV device constructs appropriate preferences. To construct the preferences, the IPTV device first identifies the device to which the preferences will apply (i.e., the IPTV device). Accordingly, in step 52 the IPTV device specifies the contact information for the IPTV device within the first preference element. In this example, because the first user wishes to apply the call rejection preferences to only the single IPTV device, the IPTV device's contact information illustrated in TABLE 3 is the only contact information inserted into the first preference element of the preferences.

TABLE 3
Contact: <sip:alice@example.com>; [header=”Contact”]; audio;video;

+g.3gpp.iari-ref=″urn:urn-7:3gpp-service.ims.icsi.iptv″

In step 54, the callee constructs the second preference element related to the contact illustrated in Table 3 which includes the caller capabilities information. In the second preference element (i.e. illustrated in Table 4), the IPTV device specifies that this element of the preferences is applicable to incoming SIP requests from any caller device that does not provide support for an IPTV application (i.e., the first user only wishes to use the IPTV device for incoming IPTV application calls).

Accordingly, the caller capabilities pattern element specified as part of a preference element (i.e. as illustrated in Table 4), applies to all caller devices that have an application identifier that does not include the g.3gpp.iari-ref containing the “urn:urn-7:3gpp-service.ims.icsi.iptv” IARI in the Contact-header. An example of such a Decline-Contact header encoding is shown in TABLE 4. In TABLE 4, the exclamation point (!) indicates a ‘not’ instruction meaning that the remainder of the header is negated (see IETF RFC2533 A Syntax for Describing Media Feature Sets for additional examples).

In step 56, the caller capabilities preference element may be embedded, for example, in the Decline-Contact header of a SIP REGISTER request for identifying when the callee does not wish to accept a call with certain characteristics (i.e. with certain capabilities, media feature tags, etc).

TABLE 4

Decline-Contact: *; [header=”Contact”]; +g.3gpp.iari-ref=″!
urn:urn-7:3gpp-service.ims.icsi.iptv″

When a callee wishes to give a higher priority to a particular caller with certain characteristics, the preferences may be defined in an Allow-Contact header.

Alternatively, the headers can be embedded into an XML, plain-text, binary or other body formats. New XML schemes and data types can be created to embed the preferences.

Referring to FIG. 1, in step 58 the action pattern element of the preferences is defined to specify that messages matching the caller capabilities pattern element (e.g., incoming session requests from devices that do not include the IPTV application) are to be rejected using a SIP 486 Busy Here response (i.e., “reject, 486”).

In step 60, the action pattern element is encoded as a directive within a SIP request as shown in TABLE 5. In the SIP request, the directive header-parameter specifies the action to be performed on the request if a match with a callee preference is found (i.e., reject, 486).

TABLE 5
Decline-Contact: *; [header=”Contact”];
+g.3gpp.iari-ref=″!urn:urn-7:3gpp-service.ims.icsi.iptv″; reject=486

After defining the preferences and constructing the SIP messages that comprise the callee's preferences, the SIP messages are communicated to one or more network component for implementation in step 62.

Upon receipt of the SIP message containing the preferences, the network node (e.g., an S-CSCF) stores the callee preferences and monitors incoming session origination requests and compares them to the preferences. In this example, upon receiving the second user's SIP INVITE voice call request to the first user, but before forwarding or communicating the request to the IPTV device, the network component retrieves the first user's IPTV device's preferences that were received in step 62 and discovers that the first user is not willing to accept calls from the non-“IPTV application” on the caller device. As a result, following the instructions in the action element (i.e., the directive header element), the network component rejects the call or session with a SIP 486 Busy Here response.

In another example, if the first user does not have a portable device and wishes to visit a different location, the first user may create preferences to forward incoming calls or sessions to another user's device (or a Voice Mail System), etc. In that case, the action pattern element of the user's preferences may specify the following: “redirect, 302, Contact: <sip:hsb9s8d=−6699a@example.com>”, wherein the contact information element identifies a device to which calls should be forwarded. In that case, the action pattern may be encoded within a SIP request as shown in TABLE 6

TABLE 6
Decline-Contact: *; [header=”Contact”];
+g.3gpp.iari-ref=″!urn:urn-7:3gpp-
service.ims.icsi.iptv″; redirect=”302, <sip:callee@192.0.2.1>;pub-
gruu=%22sip:callee@example.com;gr=urn:uuid:f81d4fae-7dec-11d0-a765-
00a0c91e6b %22”

With the forwarding preference communicated to the network, following the action pattern instructions, the network component replies to an incoming request directed to the first user's IPTV device with a 302 SIP response with forwarding information. Then, the second user's device, after having received the response and, if the device is pre-configured to automatically dial the target ID specified in the forwarding response, may initiate a new call to the device identified in the forwarding information.

If the first user wishes to give a higher priority to incoming calls that are originated from a mobile terminal, the first user may specify the mobility=“mobile” media feature tag in the Allow-Contact header of the preferences. In that case, there will be no action pattern element and a SIP request would be encoded as shown in TABLE 7.

TABLE 7

Allow-Contact: *;[header=”Contact”];mobility=”mobile”

Based upon the indication shown in TABLE 7, a network component that is responsible for call routing (e.g. an S-CSCF), may assign a higher priority to an incoming request or may simply be configured to allow all calls from devices with a mobility=“mobile” media feature tag in the contact header of the request, while prioritizing a list of first user's devices to be contacted.

In some cases, the callee's preferences may be stored in a non-SIP Server (e.g., a Web-Server) and the callee may provide a reference to the preferences in SIP REFER, REGISTER, SUBSCRIBE, MESSAGE, OPTIONS, INFO, PUBLISH requests or by non-SIP means. The preferences may be uploaded by the callee and downloaded by a network component by means of, for example, Hypertext Transfer Protocol (HTTP), Simple Object Access Protocol (SOAP), or other protocols. The policy may also be provisioned by uploading a CPL script, via Computer Supported Telecommunication Applications (CSTA), via XCAP, or using standard HTTP primitives, e.g. through a technique commonly known as REpresentational State Transfer (REST). An example SIP MESSAGE request carrying a reference to callee preferences in the Content-Type header is shown in TABLE 8. As shown in TABLE 8, the external reference is a website URL of “http://www.example.net/25/12/2009”;size=231.”

TABLE 8
MESSAGE sip:s-cscf@example.com SIP/2.0
Via: SIP/2.0/UDP alice.example.com:5060;branch=z9hG4bKn32310725
Max-Forwards: 70
To: <sip:pref-policy@example.com>
From: “Alice” <sip:alice@example.com>;tag=4563454
Call-ID: 843817637684230@3248sd5674567456
CSeq: 126 MESSAGE
Supported: gruu
Contact: <sip:alice@example.com>;+sip.instance=“<urn:uuid:f81d4fae-7dec-11d0-a765-
00a0c91e6bf6>”
Accept: message/external-body
Content-Type:message/external-body;ACCESS-TYPE=URL;
URL=“http://www.example.net/25/12/2009”;size=231
Content-Length: 0

To receive updates on a current status of the preferences being implemented by a network component, a callee may establish a subscription with an IMS networking component and receive a status of the networking component's preference configuration in SIP NOTIFY requests when the status is changed. Alternatively, to provide updates of the current callee preferences status to a callee, the IMS networking component may use an Open Mobile Alliance (OMA) PUSH (see, for example, Open Mobile Alliance, OMA-TS-SIP_Push-V1_{—}0-20081202-C, Push using SIP) mechanism, SIP MESSAGE, SIP OPTIONS, SIP INFO, SIP REFER, or SIP PUBLISH requests, for example.

A callee device may disable previously established callee preference policies (or portions thereof) by issuing a Decline-Contact or Allow-Contact headers containing a specific string, within a corresponding SIP request. For example, the headers may include “Decline-Contact: *” or “Allow-Contact: *” In these headers, the syntax containing the specific string constant (i.e., the value “*” without any additional header-parameters) indicates to an IMS networking component that the callee wishes to disable a previously established callee preferences relating to either the Decline-Contact (or Allow-Contact) depending upon which header was issued in the SIP request.

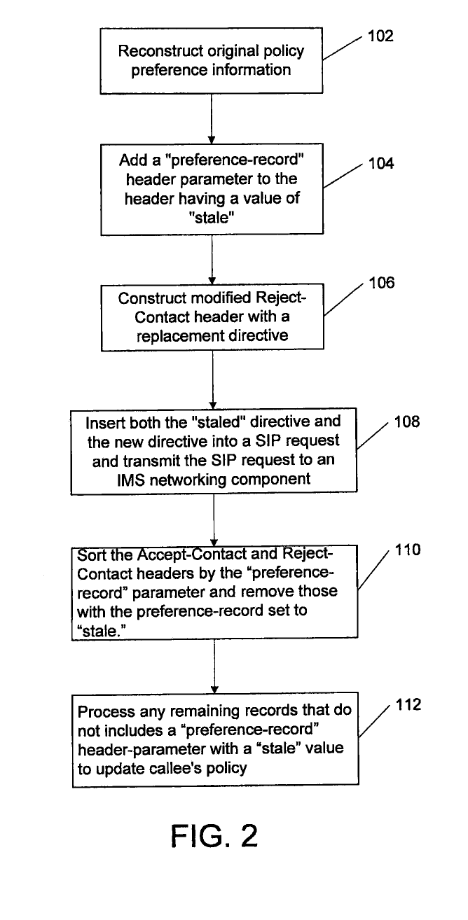

In addition to creating and disabling particular preferences, a callee device may modify its preferences by issuing a subsequent SIP REGISTRATION or other SIP request messages including the modified Allow-Contact or/and Decline-Contact headers. For example, FIG. 2 is an illustration of a method for a callee to modify its preferences using a SIP request including modified Allow-Contact or/and Decline-Contact headers. In step 102 the callee reconstructs the original header that is to be modified (e.g. Allow-Contact or Decline-Contact) including the original media-feature tags and header-parameters specified in the original format that were created when the callee originally created the preference being modified.

In step 104, the callee adds a “preference-record” header parameter to the reconstructed header with a value of “invalidate.” An example of such a Decline-Contact header is shown in TABLE 9. The preference-header parameter with the “invalidate” value indicates that the previously established Callee-Preference context for the IARI media feature tag=“!urn:urn-7:3gpp-service.ims.icsi.iptv” is now obsolete or stale which effectively deletes or removes that particular preference entry.

TABLE 9

Decline-Contact: *;[header=”Contact”];+g.3gpp.
iari-ref=″!urn:urn-7:3gpp-

service.ims.icsi.iptv″;preference-record=”invalidate”

In step 106, the callee may, in certain embodiments, construct a header with a replacement or modified directive (i.e. a Reject-Contact with a specific response code) as shown in TABLE 10.

TABLE 10
Decline-Contact: *;[header=”Contact”];+g.3gpp.iari-ref=″!urn:urn-7:3gpp-service.ims.icsi.iptv″;
reject=486

In step 108, both the header including the “invalidate” directive and the new modified directive are added to a SIP request and the SIP request is sent to an appropriate networking component (e.g., an IMS networking component).

Upon receiving the SIP request, in step 110 the network component sorts the Allow-Contact and Decline-Contact headers by the “preference-record” parameter and removes stored preference entries that match those in the received SIP request that include a preference-record set to “invalidate.” After removing the stale records, the IMS networking component processes any remaining records that do not includes a “preference-record” header-parameter with a “invalidate” value and updates the callee's preferences accordingly in step 112.

In the present system, SIP server behavior may be determined by two sets of rules—one set for processing the preferences in the Allow-Contact and Decline-Contact header fields, and a second set of rules for processing “directive” header parameters. In addition to processing the headers and the directive parameter, a server may be configured to add headers if not present, or add a value to an existing header field, as if it were a UA or UE that initiated the request. This may be useful for a server to request processing in a downstream server for the implementation of a particular feature. The message signature may include the callee preferences header fields, allowing the target server to verify that, even though servers may have added header fields, the original callee preferences are still present.

The server processing process is described below using a conversion illustrating the syntax described in this specification to RFC 2533 (see, for example, Klyne, G., “A Syntax for Describing Media Feature Sets”, RFC 2533, March 1999), followed by a matching operation and a sorting of resulting contact values. The use of RFC 2533 syntax as an intermediate step is not required, but serves as an illustration of an exemplary behavior required of the proxy.

The first step in server processing is to extract explicit preferences. To perform this operation, the server looks for, for example, the Allow-Contact and Decline-Contact header fields. For each value of the header fields, the server may extract the feature parameters. These are the header field parameters whose name may be defined in (Rosenberg, J., Schulzrinne, J., and P. Kyzivat, “Indicating User Agent Capabilities in the Session Initiation Protocol (SIP)”, RFC 3840, August 2004), or whose name begins with a plus, for example. The server may then convert the parameters to the syntax of RFC 2533, for example, based on the rules described below. After this processing, the result may include a set of feature set predicates in conjunctive normal form, each of which may be associated with one of the two preference header fields.

The server may then take each URI in the target set (e.g., the set of URI the server is going to proxy or redirect to), and may obtain its capabilities as an RFC 2533 formatted feature set predicate. This may be termed the callee contact predicate. The server may then also construct the caller contact predicates based upon the feature parameters from the caller Contact header fields of a request.

In the present implementation, a server that supports RFC 3841 (see Rosenberg, J., “Caller Preferences for the Session Initiation Protocol (SIP)”, RFC 3841, August 2004), for example, completes the matching procedure described below up to the moment when the target set is completely defined and the caller Qa is being calculated. The server then proceeds to processing the Decline-Contact header. If the server does not support the procedures defined in RFC 3841 (see Rosenberg, J., “Caller Preferences for the Session Initiation Protocol (SIP)”, RFC 3841, August 2004), for each callee contact in the target set, the server may create a matching set with caller contact predicates.

The server then computes a score for that contact against the caller contact predicates. For example, let the number of terms (conditions) in the caller contact predicate conjunction be equal to N. Each term in that predicate contains a single feature tag. If the callee contact predicate has a term containing that same feature tag, the score may be incremented by 1/N. If the feature tag was not present in the callee contact predicate, the score remains unchanged. Based upon these rules, for example, the score can range between zero and one.

The next step is to combine the scores and the q-values associated with the predicates in the matching set, to arrive at an overall caller preference, Qa. For those URIs in the target set there may be a score indicating the URI's match against each caller contact predicate in the matching set. If there are M caller contact predicates in the matching set, for example, there can be M scores (e.g., S1 through SM), for each contact. The overall caller preference, Qa, may then be defined as the arithmetic average of S1 through SM.

At this stage, any callee URIs that were removed from the target set because they were immune from caller preferences may be added back in, and Qa for that URI may be set to 1.0.

The caller preference Qa may be used to provide an ordering for any contacts remaining in the target set, if, for example, the callee has not provided an ordering. To do this, the contacts remaining in the target set may be sorted by the q-value provided by the callee. Once sorted, they may be grouped into equivalence classes, such that contacts with the same q-value may be sorted in the same equivalence class. Within each equivalence class, the contacts may then be ordered based upon their values of Qa. The result is an ordered list of contacts that can be used by the server.

For each contact in the caller contact predicate, the server may then construct a matching set with Decline-Contact headers. The callee contact is an intermediary that is used to establish the association between the caller contact and the Decline-Contact headers. The server may then apply the predicates associated with Decline-Contact header fields. Each Decline-Contact predicate (that is, each predicate associated with the Decline-Contact header field) may be examined against the caller contact predicate.

If the Decline-Contact predicate contains a filter for a feature tag, and that feature tag is not present anywhere in the caller contact predicate, that Decline-Contact predicate may be discarded for the processing of that caller contact predicate. If, however, the Decline-Contact predicate is not discarded, the predicate may be matched with the caller contact predicate using the matching operation of RFC 2533 (see, Klyne, G., “A Syntax for Describing Media Feature Sets”, RFC 2533, March 1999), for example. If the result is a match, the URI corresponding to the callee contact associated with the Decline-Contact header, may be removed from the target set. If the callee contact that is being removed from the target set is the last one, a request handling directive of the Decline-Contact header may be executed by the server.

The server may then apply the predicates associated with the Allow-Contact header fields. The Allow-Contact headers may be associated with a callee contact in the target set. For each caller contact, the server may construct a matching set. Initially, the set may contain all of the Allow-Contact predicates. Each of the predicates may then be examined. The predicates may be matched with the caller contact predicate using, for example, the matching operation of RFC 2533. For each caller contact predicate, the server may compute a score for that contact against each predicate in the Allow-Contact matching set. In one implementation, the score may be computed as follows: Let the number of terms in the Allow-Contact predicate conjunction be equal to N. Each term in that predicate contains a single feature tag. If the caller contact predicate has a term containing that same feature tag, the score may be incremented by 1/N. If the feature tag was not present in the caller contact predicate, the score may remain unchanged. Based upon these rules, the score can range between zero and one.

The maximum score from each matching set may then be multiplied by the score of the corresponding callee URIs in the target list. This is to calculate an integral overall preference of both callee and caller, Qar.

The contacts remaining in the target set may then be sorted by the q-value provided by the callee. Once sorted, the contacts are grouped into equivalence classes, such that all contacts with the same q-value are in the same equivalence class. Within each equivalence class, the contacts are then ordered based on their values of Qar. The result is an ordered list of contacts that can be used by the server.

If there are no URIs in the target set after processing, and the caller preferences were based on implicit preferences as described above, the processing above may be discarded, and the original target set, ordered by their original q-values, may be used instead. This process may be configured to handle the case where implicit preferences for the method or event packages resulted in the elimination of all potential targets. By going back to the original target set, those URIs will be tried, and may result in the generation of a 405 or 489 response, for example. The user agent client (UAC) can then use this information to try again, or report the error to the user. Without reverting to the original target set, the UAC may see a 480 response, and have no knowledge of why the request failed. In some cases, the target set may also be empty after the application of explicit preferences resulting in the generation of a 480 by the proxy. This behavior is acceptable, and indeed, may be desirable in the case of explicit preferences. When the caller makes an explicit preference, it is agreeing that its request might fail because of a preference mismatch. In this case, the server may try to return an error indicating the capabilities of the callee, so that the caller could perhaps try again. However, doing so may result in the leaking of potentially sensitive information to the caller without authorization from the callee.

If a server is recursing, the server may add the Contact header fields returned in the redirect responses to the target set, and re-apply the integral callee-caller preferences algorithm.

If the server is redirecting, the server may return all entries in the target set. In that case, the server assigns q-values to those entries so that the ordering is the same as the ordering determined by the processing above. However, the server may not include the feature parameters for the entries in the target set. If the server were to include the feature parameters for the entries in the target set, the upstream server may apply the same callee-caller preferences once more, resulting in a double application of those preferences. If the redirect server does wish to include the feature parameters in the Contact header field, the redirect server may redirect using the original target set and original q-values, before the application of callee-caller preferences.

If the request contains Decline-Contact header field with the “directive” parameter and the header field triggers removal of the last callee contact from the target set as described above, the server may execute the directive as described below, unless the server has a local policy configured to direct the server otherwise.

In the following example, a UE registers a contact for user1. The contact is shown in TABLE 11.

TABLE 11

Contact: sip:user1@example.com;audio;methods=“INVITE”;q=0.8

The registration request also contains the Allow-Contact and Decline-Contact headers shown in TABLE 12. This example illustrates which of the incoming headers to match (i.e. to compare) with when user1 receives an incoming request, for example a SIP:INVITE. In other embodiments, it is possible to use matching on different headers. For example the ‘P-Asserted-Service’ and the ‘Accept-Contact’ headers.

TABLE 12

Decline-Contact: *;[header=”Contact”];methods=″INVITE″;video
Allow-Contact: *;[header=”Contact”];audio;priority=30

An INVITE sent to the user1 contains the caller Contact header field shown in TABLE 13.

TABLE 13

Contact: sip:user2@example.com;audio;video;priority=20;
methods=“INVITE,BYE,ACK,CANCEL,UPDATE”

In this example, implicit preferences are not established as explicit preferences are, instead, provided.

The server may first process the Decline-Contact header field. In this example, because the header filter matches the caller contact sip.method feature tag “INVITE” and the feature tag sip.video, the server removes the user1 URI from the target set.

Next, the server finds that the target set is empty and the Decline-Contact header does not contain the “directive” parameter. The server may then execute the default action for the missing directive parameter—“reject”. The server can then respond with a 4xx/5xx/6xx to the INVITE request of user 2.

The present system may be configured to map feature parameters to a predicate. As an example, the Allow-Contact header field shown TABLE 14 in may be converted to the feature predicate shown in TABLE 15.

TABLE 14

Allow-Contact:*;[header=”Contact”];mobility=″fixed″
;events=″!presence,message-summary″
;language=″en,de″;description=″<PC>″;+sip.newparam
;+rangeparam=″#−4:+5.125″

TABLE 15

(& (sip.mobility=fixed)
(| (! (sip.events=presence)) (sip.events=message-summary))
(| (language=en) (language=de))
(sip.description=“PC”)
(sip.newparam=TRUE)
(rangeparam=−4..5125/1000))

TABLE 16 is an illustration of additional detail of exemplary Allow-Contact and Decline-Contact headers of the present disclosure. TABLE 16 is an extension of Table 2 of RFC 3261 (Rosenberg, J., Schulzrinne, H., Camarillo, G., Johnston, A., Peterson, J., Sparks, R., Handley, M., and E. Schooler, “SIP: Session Initiation Protocol”, RFC 3261, June 2002) for the Allow-Contact and Decline-Contact header fields.

TABLE 16

| Header | | | | | | | | |
|---|---|---|---|---|---|---|---|---|
| Field | where | proxy | ACK | BYE | CAN | INV | OPT | REG |
| Allow- | R | — | — | — | — | — | — | o |
| Contact | | | | | | | | |
| Decline- | R | — | — | — | — | — | — | o |
| Contact | | | | | | | | |

TABLE 17 is an illustration of additional detail of exemplary Allow-Contact and Decline-Contact headers of the present disclosure. TABLE 17 is an extension of Table 3 of RFC 3261 (Rosenberg, J., Schulzrinne, H., Camarillo, G., Johnston, A., Peterson, J., Sparks, R., Handley, M., and E. Schooler, “SIP: Session Initiation Protocol”, RFC 3261, June 2002) for the Allow-Contact and Decline-Contact header fields.

TABLE 17

| Header | | | | | | | | | |
|---|---|---|---|---|---|---|---|---|---|
| Field | where | proxy | PRA | UPD | SUB | NOT | INF | MSG | REF |
| Allow- | R | — | — | — | — | — | — | — | — |
| Contact | | | | | | | | | |
| Decline- | R | — | — | — | — | — | — | — | — |
| Contact | | | | | | | | | |

In TABLE 16 and TABLE 17 the column “INF” relates to the INFO method (see Donovan, S., “The SIP INFO Method”, RFC 2976, October 2000), “PRA” relates to the PRACK method (see Rosenberg, J. and H. Schulzrinne, “Reliability of Provisional Responses in Session Initiation Protocol (SIP)”, RFC 3262, June 2002), “UPD” relates to the UPDATE method (see Rosenberg, J., “The Session Initiation Protocol (SIP) UPDATE Method”, RFC 3311, October 2002), “SUB” relates to the SUBSCRIBE method (see Roach, A. B., “Session Initiation Protocol (SIP)-Specific Event Notification”, RFC 3265, June 2002), “NOT” relates to the NOTIFY method (see Roach, A. B., “Session Initiation Protocol (SIP)-Specific Event Notification”, RFC 3265, June 2002), “MSG” relates to the MESSAGE method (see Campbell, B., Ed., Rosenberg, J., Schulzrinne, H., Huitema, C., and D. Gurle, “Session Initiation Protocol (SIP) Extension for Instant Messaging”, RFC 3428, December 2002, and “REF” relates to the REFER method (see Sparks, R., “The Session Initiation Protocol (SIP) Refer Method”, RFC 3515, April 2003).

In the present system, as discussed above, the “directive” header parameter may specify callee preferences for how a server may process a request. The value of the “directive” header parameter is a token that specifies a particular directive. In one implementation, there may only be one directive of each type per request (e.g., you cannot have both “reject” and “redirect” in the same “directive” header parameter).

When the callee specifies a directive, the server may honor that directive. The following types of directives may be defined. reject-directive: This type of directive indicates whether the callee would like the server to reject (“reject”) the request. redirect-directive: This type of directive indicates whether the callee would like the server to redirect (“redirect”) the request. proxy-directive: This type of directive indicates whether the callee would like the server to proxy (“proxy”) the request. In one example, the default value of the directive header parameter for the Allow-Contact header may be proxy-directive and for the Decline-Contact header may be reject-directive. If the header parameter is not presented in the headers, the default value may be applied by the server processing this request.

In the present system, it may be necessary to consider one or more security considerations. For example, the presence of callee preferences in a request has an effect on the ways in which the request is handled at a server. As a result, requests with callee preferences may be integrity-protected with, for example, the sips mechanism specified in RFC 3261. Also, the processing of callee preferences requires set operations and searches that may require some amount of computation. This may enable a denial of service (DOS) attack whereby a user can send requests with substantial numbers of caller preferences, in the hopes of overloading the server. To protect against this, servers may reject requests with too many rules. In one implementation, a reasonable number of rules is defined as 60.

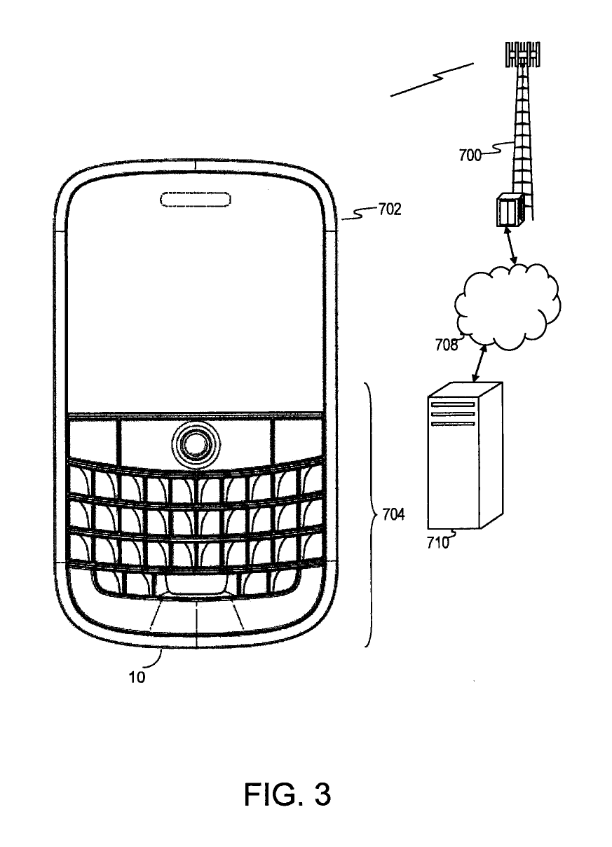

FIG. 3 illustrates a wireless communications system including an embodiment of a device or UE of the present system. UE 10 is operable for implementing aspects of the disclosure, but the disclosure should not be limited to these implementations. Though illustrated as a mobile phone, the UE 10 may take various forms including a wireless handset, a pager, a personal digital assistant (PDA), a portable computer, a tablet computer, a laptop computer. Many suitable devices combine some or all of these functions. In some embodiments of the disclosure, the UE 10 is not a general purpose computing device like a portable, laptop or tablet computer, but rather is a special-purpose communications device such as a mobile phone, a wireless handset, a pager, a PDA, or a telecommunications device installed in a vehicle. The UE 10 may also be a device, include a device, or be included in a device that has similar capabilities but that is not transportable, such as a desktop computer, a set-top box, or a network node. The UE 10 may support specialized activities such as gaming, inventory control, job control, and/or task management functions, and so on.

The UE 10 includes a display 702. The UE 10 also includes a touch-sensitive surface, a keyboard or other input keys generally referred as 704 for input by a user. The keyboard may be a full or reduced alphanumeric keyboard such as QWERTY, Dvorak, AZERTY, and sequential types, or a traditional numeric keypad with alphabet letters associated with a telephone keypad. The input keys may include a trackwheel, an exit or escape key, a trackball, and other navigational or functional keys, which may be inwardly depressed to provide further input function. The UE 10 may present options for the user to select, controls for the user to actuate, and/or cursors or other indicators for the user to direct.

The UE 10 may further accept data entry from the user, including numbers to dial or various parameter values for configuring the operation of the UE 10. The UE 10 may further execute one or more software or firmware applications in response to user commands. These applications may configure the UE 10 to perform various customized functions in response to user interaction. Additionally, the UE 10 may be programmed and/or configured over-the-air, for example from a wireless base station, a wireless access point, or a peer UE 10.

Among the various applications executable by the UE 10 are a web browser, which enables the display 702 to show a web page. The web page may be obtained via wireless communications with a wireless network access node, a cell tower, a peer UE 10, or any other wireless communication network or system 700. The network 700 is coupled to a wired network 708, such as the Internet. Via the wireless link and the wired network, the UE 10 has access to information on various servers, such as a server 710. The server 710 may provide content that may be shown on the display 702. Alternately, the UE 10 may access the network 700 through a peer UE 10 acting as an intermediary, in a relay type or hop type of connection.

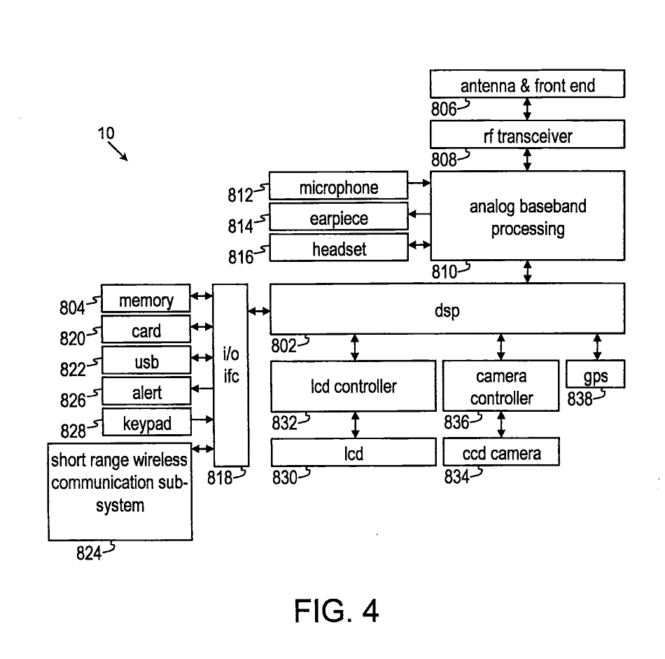

FIG. 4 shows a block diagram of the UE 10. While a variety of known components of UEs 110 are depicted, in an embodiment a subset of the listed components and/or additional components not listed may be included in the UE 10. The UE 10 includes a digital signal processor (DSP) 802 and a memory 804. As shown, the UE 10 may further include an antenna and front end unit 806, a radio frequency (RF) transceiver 808, an analog baseband processing unit 810, a microphone 812, an earpiece speaker 814, a headset port 816, an input/output interface 818, a removable memory card 820, a universal serial bus (USB) port 822, a short range wireless communication sub-system 824, an alert 826, a keypad 828, a liquid crystal display (LCD), which may include a touch sensitive surface 830, an LCD controller 832, a charge-coupled device (CCD) camera 834, a camera controller 836, and a global positioning system (GPS) sensor 838. In an embodiment, the UE 10 may include another kind of display that does not provide a touch sensitive screen. In an embodiment, the DSP 802 may communicate directly with the memory 804 without passing through the input/output interface 818.

The DSP 802 or some other form of controller or central processing unit operates to control the various components of the UE 10 in accordance with embedded software or firmware stored in memory 804 or stored in memory contained within the DSP 802 itself. In addition to the embedded software or firmware, the DSP 802 may execute other applications stored in the memory 804 or made available via information carrier media such as portable data storage media like the removable memory card 820 or via wired or wireless network communications. The application software may comprise a compiled set of machine-readable instructions that configure the DSP 802 to provide the desired functionality, or the application software may be high-level software instructions to be processed by an interpreter or compiler to indirectly configure the DSP 802.

The antenna and front end unit 806 may be provided to convert between wireless signals and electrical signals, enabling the UE 10 to send and receive information from a cellular network or some other available wireless communications network or from a peer UE 10. In an embodiment, the antenna and front end unit 806 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 806 may include antenna tuning and/or impedance matching components, RF power amplifiers, and/or low noise amplifiers.

The RF transceiver 808 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 810 and/or the DSP 802 or other central processing unit. In some embodiments, the RF Transceiver 808, portions of the Antenna and Front End 806, and the analog baseband processing unit 810 may be combined in one or more processing units and/or application specific integrated circuits (ASICs).

The analog baseband processing unit 810 may provide various analog processing of inputs and outputs, for example analog processing of inputs from the microphone 812 and the headset 816 and outputs to the earpiece 814 and the headset 816. To that end, the analog baseband processing unit 810 may have ports for connecting to the built-in microphone 812 and the earpiece speaker 814 that enable the UE 10 to be used as a cell phone. The analog baseband processing unit 810 may further include a port for connecting to a headset or other hands-free microphone and speaker configuration. The analog baseband processing unit 810 may provide digital-to-analog conversion in one signal direction and analog-to-digital conversion in the opposing signal direction. In some embodiments, at least some of the functionality of the analog baseband processing unit 810 may be provided by digital processing components, for example by the DSP 802 or by other central processing units.

The DSP 802 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 802 may perform modulation, coding, interleaving, and spreading, and for a receiver function the DSP 802 may perform despreading, deinterleaving, decoding, and demodulation. In another embodiment, for example in an orthogonal frequency division multiplex access (OFDMA) technology application, for the transmitter function the DSP 802 may perform modulation, coding, interleaving, inverse fast Fourier transforming, and cyclic prefix appending, and for a receiver function the DSP 802 may perform cyclic prefix removal, fast Fourier transforming, deinterleaving, decoding, and demodulation. In other wireless technology applications, yet other signal processing functions and combinations of signal processing functions may be performed by the DSP 802.

The DSP 802 may communicate with a wireless network via the analog baseband processing unit 810. In some embodiments, the communication may provide Internet connectivity, enabling a user to gain access to content on the Internet and to send and receive e-mail or text messages. The input/output interface 818 interconnects the DSP 802 and various memories and interfaces. The memory 804 and the removable memory card 820 may provide software and data to configure the operation of the DSP 802. Among the interfaces may be the USB interface 822 and the short range wireless communication sub-system 824. The USB interface 822 may be used to charge the UE 10 and may also enable the UE 10 to function as a peripheral device to exchange information with a personal computer or other computer system. The short range wireless communication sub-system 824 may include an infrared port, a Bluetooth interface, an IEEE 802.11 compliant wireless interface, or any other short range wireless communication sub-system, which may enable the UE 10 to communicate wirelessly with other nearby mobile devices and/or wireless base stations.

The input/output interface 818 may further connect the DSP 802 to the alert 826 that, when triggered, causes the UE 10 to provide a notice to the user, for example, by ringing, playing a melody, or vibrating. The alert 826 may serve as a mechanism for alerting the user to any of various events such as an incoming call, a new text message, and an appointment reminder by silently vibrating, or by playing a specific pre-assigned melody for a particular caller.

The keypad 828 couples to the DSP 802 via the interface 818 to provide one mechanism for the user to make selections, enter information, and otherwise provide input to the UE 10. The keyboard 828 may be a full or reduced alphanumeric keyboard such as QWERTY, Dvorak, AZERTY and sequential types, or a traditional numeric keypad with alphabet letters associated with a telephone keypad. The input keys may include a trackwheel, an exit or escape key, a trackball, and other navigational or functional keys, which may be inwardly depressed to provide further input function. Another input mechanism may be the LCD 830, which may include touch screen capability and also display text and/or graphics to the user. The LCD controller 832 couples the DSP 802 to the LCD 830.

The CCD camera 834, if equipped, enables the UE 10 to take digital pictures. The DSP 802 communicates with the CCD camera 834 via the camera controller 836. In another embodiment, a camera operating according to a technology other than Charge Coupled Device cameras may be employed. The GPS sensor 838 is coupled to the DSP 802 to decode global positioning system signals, thereby enabling the UE 10 to determine its position. Various other peripherals may also be included to provide additional functions, e.g., radio and television reception.

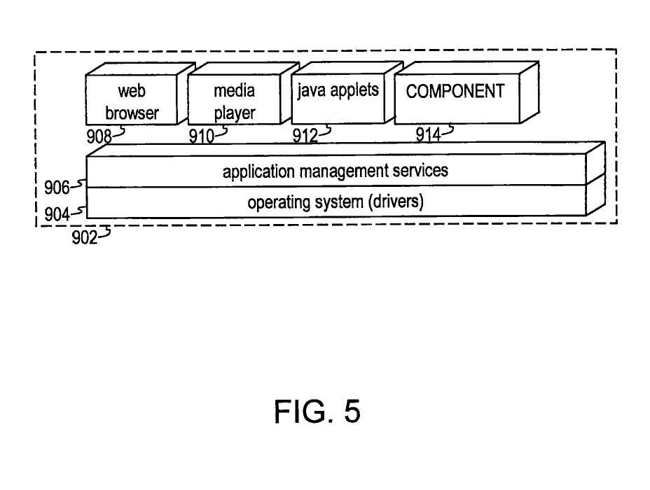

FIG. 5 illustrates a software environment 902 that may be implemented by the DSP 802. The DSP 802 executes operating system drivers 904 that provide a platform from which the rest of the software operates. The operating system drivers 904 provide drivers for the UE hardware with standardized interfaces that are accessible to application software. The operating system drivers 904 include application management services (“AMS”) 906 that transfer control between applications running on the UE 10. Also shown in FIG. 5 are a web browser application 908, a media player application 910, and Java applets 912. The web browser application 908 configures the UE 10 to operate as a web browser, allowing a user to enter information into forms and select links to retrieve and view web pages. The media player application 910 configures the UE 10 to retrieve and play audio or audiovisual media. The Java applets 912 configure the UE 10 to provide games, utilities, and other functionality. A component 914 might provide functionality described herein.

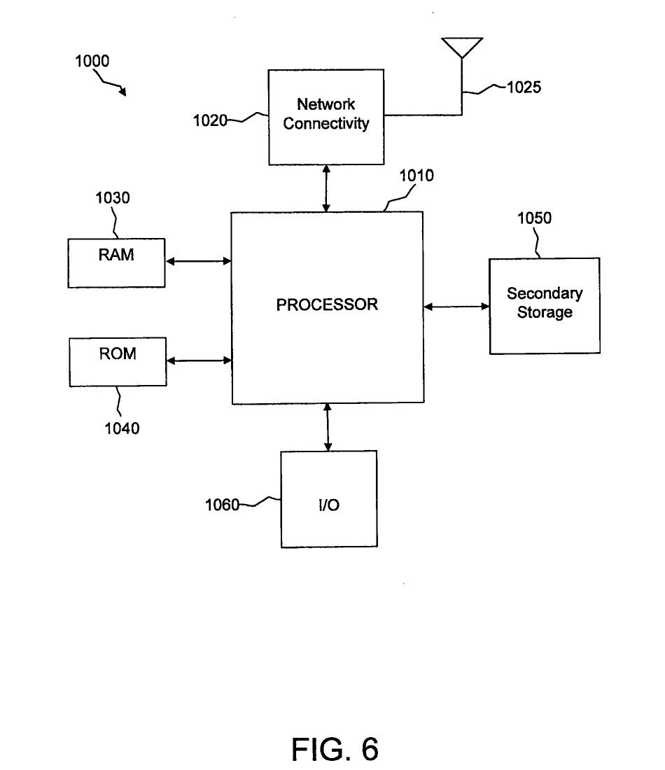

The UE 10, base station 12, and other components described above might include a processing component that is capable of executing instructions related to the actions described above. FIG. 6 illustrates an example of a system 1000 that includes a processing component 1010 suitable for implementing one or more embodiments disclosed herein. In addition to the processor 1010 (which may be referred to as a central processor unit (CPU or DSP), the system 1000 might include network connectivity devices 1020, random access memory (RAM) 1030, read only memory (ROM) 1040, secondary storage 1050, and input/output (I/O) devices 1060. In some embodiments, a program for implementing the determination of a minimum number of HARQ process IDs may be stored in ROM 1040. In some cases, some of these components may not be present or may be combined in various combinations with one another or with other components not shown. These components might be located in a single physical entity or in more than one physical entity. Any actions described herein as being taken by the processor 1010 might be taken by the processor 1010 alone or by the processor 1010 in conjunction with one or more components shown or not shown in the drawing.

The processor 1010 executes instructions, codes, computer programs, or scripts that it might access from the network connectivity devices 1020, RAM 1030, ROM 1040, or secondary storage 1050 (which might include various disk-based systems such as hard disk, floppy disk, or optical disk). While only one processor 1010 is shown, multiple processors may be present. Thus, while instructions may be discussed as being executed by a processor, the instructions may be executed simultaneously, serially, or otherwise by one or multiple processors. The processor 1010 may be implemented as one or more CPU chips.

The network connectivity devices 1020 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1020 may enable the processor 1010 to communicate with the Internet or one or more telecommunications networks or other networks from which the processor 1010 might receive information or to which the processor 1010 might output information.

The network connectivity devices 1020 might also include one or more transceiver components 1025 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1025 might include separate receiving and transmitting units or a single transceiver. Information transmitted or received by the transceiver 1025 may include data that has been processed by the processor 1010 or instructions that are to be executed by processor 1010. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1030 might be used to store volatile data and perhaps to store instructions that are executed by the processor 1010. The ROM 1040 is a non-volatile memory device that typically has a smaller memory capacity than the memory capacity of the secondary storage 1050. ROM 1040 might be used to store instructions and perhaps data that are read during execution of the instructions. Access to both RAM 1030 and ROM 1040 is typically faster than to secondary storage 1050. The secondary storage 1050 is typically comprised of one or more disk drives or tape drives and might be used for non-volatile storage of data or as an over-flow data storage device if RAM 1030 is not large enough to hold all working data. Secondary storage 1050 may be used to store programs that are loaded into RAM 1030 when such programs are selected for execution.

The I/O devices 1060 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1025 might be considered to be a component of the I/O devices 1060 instead of or in addition to being a component of the network connectivity devices 1020. Some or all of the I/O devices 1060 may be substantially similar to various components depicted in the previously described drawing of the UE 10, such as the display 702 and the input 704.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To apprise the public of the scope of this disclosure, the following claims are made:

What is claimed is:

1. A method of communicating callee device preferences to a network, comprising:
transmitting a first device identification, the first device identification at least one of identifying the callee device and describing a capability of the callee device;
encoding a caller capabilities pattern into a first session initiation protocol (SIP) message, the caller capabilities pattern describing an attribute of a candidate caller device;
encoding an action pattern into the first SIP message, the action pattern defining an action, the network being configured to take the action, the action pattern being associated with the caller capabilities pattern; and
transmitting the first SIP message to the network.

2. The method of claim 1, wherein transmitting the first SIP message to the network includes transmitting the first SIP message to at least one of a serving call session control function (S-CSCF), proxy CSCF (P-CSCF), Media Gateway Controller Function (MGCF) and an application server (AS).

3. The method of claim 1, wherein encoding an action pattern into the first SIP message includes encoding the action pattern into at least one of an Accept-Contact header and a Reject-Contact header of the first SIP message.

4. The method of claim 1, wherein the action pattern includes at least one of a reject directive, a redirect directive, and a proxy-directive.

5. The method of claim 1, including:
modifying the first SIP message to include a preference-record header, the preference-record header having a stale value;
transmitting the modified first SIP message to the network;
encoding at least one of a second caller capabilities pattern and a second action pattern into a second SIP message;
transmitting the second SIP message to the network.

6. A method of receiving callee device preferences, comprising:
receiving a first device identification, the first device identification at least one of identifying a callee device and describing a capability of the callee device;
receiving a first session initiation protocol (SIP) message, the first SIP message including:
a caller capabilities pattern encoded into the first SIP message, the caller capabilities pattern describing an attribute of a candidate caller device, and
an action pattern encoded into the first SIP message, the action pattern defining an action, the action pattern being associated with the caller capabilities pattern; and
using the caller capabilities pattern and the action pattern to process requests directed to the first device.

7. The method of claim 6, wherein the first SIP message is received by at least one of a serving call session control function (S-CSCF), proxy CSCF (P-CSCF), Media Gateway Controller Function (MGCF) and an application server (AS).

8. The method of claim 6, wherein the action pattern is encoded into at least one of an Accept-Contact header and a Reject-Contact header of the first SIP message.

9. The method of claim 6, wherein the action pattern includes at least one of a reject directive, a redirect directive, and a proxy-directive.

10. The method of claim 6, including:
receiving a modified first SIP message, the modified first SIP message including a preference-record header, the preference-record header having a stale value;
receiving a second SIP message, the second SIP message including at least one of a second caller capabilities pattern and a second action pattern; and
using the at least one of the second caller capabilities pattern and the second action pattern to process requests directed to the first device.

11. The method of claim 6, wherein using the caller capabilities pattern and the action pattern to process requests directed to the first device includes:
receiving a call or session request from a caller device;
comparing an attribute of the caller device to the caller capabilities pattern; and
when the attribute of the caller device matches the caller capabilities pattern, processing the call or session request of the caller device by taking an action defined in the action pattern.

12. A user equipment, comprising:
a processor, the processor being configured to:
transmit a first device identification, the first device identification at least one of identifying a callee device and describing a capability of the callee device;
encode a caller capabilities pattern into a first session initiation protocol (SIP) message, the caller capabilities pattern describing an attribute of a candidate caller device;
encode an action pattern into the first SIP message, the action pattern defining an action, the action pattern being associated with the caller capabilities pattern; and
transmit the first SIP message to a network.

13. The user equipment of claim 12, wherein the processor is configured to transmit the first SIP message to at least one of a serving call session control function (S-CSCF), proxy CSCF (P-CSCF), Media Gateway Controller Function (MGCF) and an application server (AS).

14. The user equipment of claim 12, wherein the processor is configured to encode the action pattern into at least one of an Accept-Contact header and a Reject-Contact header of the first SIP message.

15. The user equipment of claim 12, wherein the action pattern includes at least one of a reject directive, a redirect directive, and a proxy-directive.

16. The user equipment of claim 12, wherein the processor is configured to:
modify the first SIP message to include a preference-record header, the preference-record header having a stale value;
transmit the modified first SIP message to the network;
encode at least one of a second caller capabilities pattern and a second action pattern into a second SIP message;
transmit the second SIP message to the network.

17. A network component, comprising:
a processor, the processor being configured to:
receive a first device identification, the first device identification at least one of identifying a callee device and describing a capability of the callee device;
receive a first session initiation protocol (SIP) message, the first SIP message including:
a caller capabilities pattern encoded into the first SIP message, the caller capabilities pattern describing an attribute of a candidate caller device, and
an action pattern encoded into the first SIP message, the action pattern defining an action, the action pattern being associated with the caller capabilities pattern; and
use the caller capabilities pattern and the action pattern to process requests directed to the first device.

18. The network component of claim 17, wherein the first SIP message is received by at least one of a serving call session control function (S-CSCF), proxy CSCF (P-CSCF), Media Gateway Controller Function (MGCF) and an application server (AS).

19. The network component of claim 17, wherein the action pattern is encoded into at least one of an Accept-Contact header and a Reject-Contact header of the first SIP message.

20. The network component of claim 17, wherein the action pattern includes at least one of a reject directive, a redirect directive, and a proxy-directive.

21. The network component of claim 17, wherein the processor is configured to:
receive a modified first SIP message, the modified first SIP message including a preference-record header, the preference-record header having a stale value;
receive a second SIP message, the second SIP message including at least one of a second caller capabilities pattern and a second action pattern; and
use the at least one of the second caller capabilities pattern and the second action pattern to process requests directed to the first device.

22. The network component of claim 17, wherein the processor is configured to:
receive a call or session request from a caller device;
compare an attribute of the caller device to the caller capabilities pattern; and
when the attribute of the caller device matches the caller capabilities pattern, process the call or session request of the caller device by taking an action defined in the action pattern.
